(19) United States
(12) Patent Application Publication
(10) Pub. No.: US 2014/0272091 A1
(43) Pub. Date: Sep. 18, 2014

(54) MEAT PASTE NOODLE

(71) Applicant: Zengyu Hui, Zhucheng (CN)

(72) Inventor: Zengyu Hui, Zhucheng (CN)

(73) Assignee: Shandong Huifa Food Corporation Co., Ltd., Zhucheng (CN)

(21) Appl. No.: 14/125,082

(22) PCT Filed: Aug. 8, 2012
(86) PCT No.: PCT/CN2012/079815

§ 371 Date: Dec. 9, 2013

(51) Int. Cl. A23L 1/317

(52) U.S. Cl. CPC A23L 1/3177
USPC 426/643

(57) ABSTRACT

The present invention discloses a meat paste noodle. The meat paste noodle comprises raw materials and auxiliary materials. The raw materials comprise fish, chicken, eggs, fat of swine, starch, soy protein and water. The auxiliary materials comprise salts, sugars, gourmet powders, meat flavor powders, meat flavor oil and ethyl maltol. In the present invention, main raw materials of the fish, chicken and fat of swine and the like are subjected to cutting, grinding and chopping to form fillings, and the fillings are prepared into the meat paste noodle by a noodle forming machine and a filament cutter. The meat paste noodle of the present invention contains a plenty of folic acids and nutrient elements required by human bodies, such as a plenty of proteins, various vitamins and mineral substances.

### CROSS-REFERENCE TO RELATED APPLICATIONS

This application is the U.S. national phase of International Application No. PCT/CN2012/079815 filed on 8 Aug. 2012, the entire contents of which is hereby incorporated by reference.

### BACKGROUND OF THE INVENTION

1. Field of the Invention

The present invention relates to a food, and particularly to a meat paste noodle and a processing method for mass producing the noodle.

2. Background of the Invention

Currently there is a wide variety of noodles in the market. A common noodle is simply and directly produced from flour. This noodle is of less nutritional value. In order to enhance nutrition of noodles, vegetarian noodles such as spinach noodles, celery suitable and the like has been gradually developed which are suitable for people at all ages to eat. Egg and vegetables noodles of a high nutritional value have also been developed. However, these noodles lack of the large amount of nutrients contained in meat, especially nutrients contained fish. China is rich in aquatic products, and the production of fish is increasing gradually. However, the methods for processing and eating fish are relatively narrow, so that the utilization ratio of high protein, low fat, rich vitamins and mineral substances which are contained in fish is greatly limited. Thus, it is imperative to develop a method for processing noodle by using fish.

### BRIEF SUMMARY OF THE INVENTION

The technical problem to be solved by the present invention is to provide a meat paste noodle with a balanced nutrition and good taste.

In order to solve the above technical problem, the technical solution of the present invention lies in a meat paste noodle, which comprises the following raw materials in parts by weight:
main raw materials: fish 30-40 parts, chicken 20-30 parts, eggs 3-5 parts, fat of swine 5-7 parts, starch 5-10 parts, soy protein 5-8 parts, water 10-20 parts;
auxiliary materials: salts 0.5-2%, sugars 1-2.5%, gourmet powders 0.2-0.6%, meat flavor powders 0.1-0.3%, meat flavor oil 0.1-0.3%, ethyl maltol 0.01-0.03%, and said auxiliary materials are added in percentage by weight with respect to said main raw materials;
the meat paste noodle further comprises a processing method comprising the steps of:
step 1, cutting meat materials
cutting said fish and chicken in the main raw materials into pieces, and maintaining the cut fish pieces and chicken pieces at a temperature between −2° C. and +2° C.; cutting said fat of swine in the main raw materials in a frozen state into pieces, grinding pieces of said fat of swine with a 6-8 mm grinder plate, and maintaining the ground fat of swine at a temperature between 0° C. and 4° C.; and freezing said water in the main raw materials into an ice-water mixed state;
step 2, chopping
mixing said fish pieces and chicken pieces in step 1 with said salts in the auxiliary materials, chopping into a meat paste state with a chopper at 3200-3700 rpm for 6-8 minutes, adding the ground fat of swine in step 1 and said eggs, starch and soy protein in the main raw materials into the meat paste, chopping into a meat paste state with the chopper at 2500-3200 rpm for 5-7 minutes, then adding the remaining auxiliary materials except for salts and said ice-water in step 1, chopping with the chopper at 2200-2700 rpm for 3-5 minutes to form uniformly mixed fillings, and maintaining said fillings at a temperature between −1.8° C. and 4° C.;
step 3, placing meat fillings
sterilizing a filling machine with 150 ppm chlorine dioxide for 5-7 minutes, cleaning up said filling machine with clean water, placing said fillings in step 2 into the sterilized filling machine, and then putting said filling machine in a standing room to stand for 100-120 minutes;
step 4, molding meat paste noodle
a) connecting a discharge port of a pump in the noodle forming machine with a filling tube, clamping with a clip, adding gradually said fillings after standing in step 3 into the pump of the noodle forming machine, starting the pump of said noodle forming machine, and transferring said fillings to the discharge port of said filling tube by using said pump;
b) cleaning up the inside space of a drum-type heating and cooling machine, increasing the drumming steam temperature of the drum-type heating and cooling machine to an outside temperature between 90° C. and 95° C. and an inside temperature between 95° C. and 99° C., then transferring fillings from the discharge port of said filling tube into the drum-type heating and cooling machine, and outputting a meat paste dough sheet with a smooth surface from an output end of the drum-type heating and cooling machine;
step 5, cutting and shaping meat paste noodle
cutting the meat paste dough sheet output from the drum-type heating and cooling machine into strips with a filament cutter, and forming meat paste noodle, the cut meat paste noodle having a length of 22-30 cm, a thickness of 2-5 mm, a width of 2-5 mm and a weight of 1-2 g per strip;
step 6, arranging and freezing
shaking the cut meat paste noodle into a separated state, arranging it flatly in a single row within trays, and loading the trays into a refrigeratory for freezing according to the processing order of the meat paste noodle, wherein the refrigeratory is maintained at a temperature not higher than −25° C. and the freezing time is 4-6 hours.

As an improvement to the above technical solution, said auxiliary materials are added in the following percentages by weight with respect to said main raw materials: salts 1%, sugars 1.2%, gourmet powders 0.4%, meat flavor powders 0.2%, meat flavor oil 0.2%, and ethyl maltol 0.02%.

Due to the adoption of the above technical solution, the present invention has the following beneficial effects. Main raw materials of the fish, chicken and fat of swine and the like are subjected to cutting, grinding and chopping to form fillings, and the fillings are prepared into the meat paste noodle by a noodle forming machine and a filament cutter. The meat paste noodle of the present invention contains a plenty of folic acids and nutrient elements required by human bodies, such as a plenty of proteins, various vitamins and mineral substances. The chicken is added in the noodle, so that the nutrient elements are increased and taste of the meat paste noodle is improved. The noodle is fresh and tender, chewy, crispy and easy to digest. The noodle is suitable for people at all ages to eat.

### DETAILED DESCRIPTION OF THE INVENTION

In the following detailed description, some exemplary embodiments of the present invention will be described in an illustrative way. It is apparent for the ordinary skilled in the art that various modifications can be made to the described embodiments without departing from the spirit and scope of the present invention.

A meat paste noodle comprises the following raw materials in parts by weight:
main raw materials: fish 30-40 parts, chicken 20-30 parts, eggs 3-5 parts, fat of swine 5-7 parts, starch 5-10 parts, soy protein 5-8 parts, water 10-20 parts; and
auxiliary materials: salts 0.5-2%, sugars 1-2.5%, gourmet powders 0.2-0.6%, meat flavor powders 0.1-0.3%, meat flavor oil 0.1-0.3%, ethyl maltol 0.01-0.03%, and said auxiliary materials are added in percentage by weight with respect to said main raw materials.

In the present embodiment, the contents of raw materials for meat paste noodle as well as its processing method will be described in detail by taking 100 kg of main raw materials as an example.

The main raw materials comprise fish 35 kg, chicken 25 kg, eggs 4 kg, fat of swine 6 kg, starch 8 kg, soy protein 6 kg, water 16 kg.

Said auxiliary materials are added in percentage by weight with respect to said main raw materials, and comprise salts 1 kg, sugars 1.2 kg, gourmet powders 0.4 kg, meat flavor powders 0.2 kg, meat flavor oil 0.2 kg, ethyl maltol 0.02 kg.

In the present embodiment, the meat paste noodle is fabricated by the following processing steps.

Step 1, cutting meat materials
35 kg fish and 25 kg chicken are cut into pieces, and the cut fish pieces and chicken pieces are maintained at a temperature between −2° C. and +2° C. 6 kg fat of swine is cut into pieces in a frozen state, pieces of said fat of swine are ground with a 6-8 mm grinder plate, and the ground fat of swine is maintained at a temperature between 0° C. and 4° C. 16 kg water is frozen to an ice-water mixed state.

Step 2, chopping

Said fish pieces and chicken pieces in step 1 are mixed with 1 kg salts, and chopped into a meat paste state with a chopper at 3500 rpm for 6 minutes. The ground fat of swine in step 1, as well as 4 kg eggs, 8 kg starch and 6 kg soy protein, is added into the meat paste, and chopped into a meat paste state with the chopper at 3000 rpm for 5 minutes. Then the remaining auxiliary materials except for salts and said ice-water in step 1 are added, and chopped with the chopper at 2500 rpm for 3 minutes to form uniformly mixed fillings. The said fillings are maintained at a temperature between −1.8° C. and 4° C.

Step 3, placing meat fillings

A filling machine is sterilized with 150 ppm chlorine dioxide for 5 minutes. Said filling machine is cleaned up with clean water, said fillings in step 2 are placed into the sterilized filling machine, and then said filling machine is put in a standing room to stand for 100-120 minutes.

Step 4, molding meat paste noodle
a) A discharge port of a pump in the noodle forming machine is connected with a filling tube, and is clamped with a clip. Said fillings after standing in the filling machine are added gradually into the pump of the noodle forming machine. During adding fillings, it is required to add a small amount frequently, and avoid spreading the fillings. The pump of said noodle forming machine is started, and said fillings are transferred to the discharge port of said filling tube by using said pump.
b) The inside space of a drum-type heating and cooling machine is cleaned up to avoid affecting the quality of dough sheet. The drumming steam temperature of the drum-type heating and cooling machine is increased to an outside temperature between 90° C. and 95° C. and an inside temperature between 95° C. and 99° C. If the drum temperature is too low or high, the dough sheet will stick to the drum, so that the surface of dough sheet is not smooth enough. Then fillings are transferred from the discharge port of said filling tube into the drum-type heating and cooling machine, and a meat paste dough sheet with a smooth surface is output from an output end of the drum-type heating and cooling machine.

During the processing of the meat paste noodle, it is necessary to frequently clean up filling slags, dirts, oils and the like on the drum surface, and timely remove obstacles in the molding head. This helps to avoid the quality of the meat paste dough sheet, and ensure that the output meat paste dough sheet has a uniform thickness on both sides and that both sides are flat.

Step 5, cutting and shaping meat paste noodle

The meat paste dough sheet output from the drum-type heating and cooling machine is cut into strips with a filament cutter to form meat paste noodle. The cut meat paste noodle has a length of 25 cm, a thickness of 3 mm, a width of 3 mm and a weight of 1.5 g per strip.

Step 6, arranging and freezing

The cut meat paste noodle is shaken into a separated state, and arranged flatly in a single row within trays. The trays are loaded into a refrigeratory for freezing according to the processing order of the meat paste noodle. The refrigeratory is maintained at a temperature not higher than −25° C. and the freezing time is 4-6 hours. Then, the trays are moved out of the refrigeratory in a state that the temperature of the meat paste noodle is not higher than −18° C.

During mass production in the production workshop, the meat paste noodle which has been moved out of the refrigeratory should be placed into packaging bags quickly. The packaging bags are sealed with a heat sealing machine. The meat paste noodle in the sealed packaging bags is packed in a box, and then refrigerated in the refrigeratory at −18° C.

The meat paste noodle of the present invention is simple to process for eating. For example, a pot can be filled with oil to its half capacity, and the oil is heated up to about 165° C. Then the meat paste noodle is fried for 45 seconds to become golden. The fried meat paste noodle is crispy and delicious. The meat paste noodle may also be prepared as staple food by scalding in boiling water, boiling, roasting, or heating with a microwave oven, so that it is both nutrition and affordable.

In the present invention, the fish can also be prepared by deep-sea fish. By using deep-sea fish, the meat paste noodle has the advantages of high protein, low fat, rich vitamins and mineral substances, and the like. In addition, the noodle is fresh and tender, chewy, crispy and easy to digest. The noodle is suitable for people at all ages to eat.

It has to be noted that the basic principle, main features, and advantages of the present invention have been described above. It's understood by the skilled in the art that the present invention is not limited to the above embodiments. These embodiments and the description only describe the principle of the present invention. Various modifications and improvements to the present invention can be made without departing from the spirit and scope of the present invention, and all such modifications and improvements fall within the protection scope of the present invention. The protection scope of the present invention is defined in the following claims and the equivalents thereto.

What is claimed is:

1. A meat paste noodle, characterized in that the meat paste noodle comprises the following raw materials in parts by weight:
main raw materials: fish 30-40 parts, chicken 20-30 parts, eggs 3-5 parts, fat of swine 5-7 parts, starch 5-10 parts, soy protein 5-8 parts, water 10-20 parts;
auxiliary materials: salts 0.5-2%, sugars 1-2.5%, gourmet powders 0.2-0.6%, meat flavor powders 0.1-0.3%, meat flavor oil 0.1-0.3%, ethyl maltol 0.01-0.03%, and said auxiliary materials are added in percentage by weight with respect to said main raw materials;
further comprising a processing method comprising the steps of:
step 1, cutting meat materials
cutting said fish and chicken in the main raw materials into pieces, and maintaining the cut fish pieces and chicken pieces at a temperature between −2° C. and +2° C.; cutting said fat of swine in the main raw materials in a frozen state into pieces, grinding pieces of said fat of swine with a 6-8 mm grinder plate, and maintaining the ground fat of swine at a temperature between 0° C. and 4° C.; and freezing said water in the main raw materials into an ice-water mixed state;
step 2, chopping
mixing said fish pieces and chicken pieces in step 1 with said salts in the auxiliary materials, chopping into a meat paste state with a chopper at 3200-3700 rpm for 6-8 minutes, adding the ground fat of swine in step 1 and said eggs, starch and soy protein in the main raw materials into the meat paste, chopping into a meat paste state with the chopper at 2500-3200 rpm for 5-7 minutes, then adding the remaining auxiliary materials except for salts and said ice-water in step 1, chopping with the chopper at 2200-2700 rpm for 3-5 minutes to form uniformly mixed fillings, and maintaining said fillings at a temperature between −1.8° C. and 4° C.;
step 3, placing meat fillings
sterilizing a filling machine with 150 ppm chlorine dioxide for 5-7 minutes, cleaning up said filling machine with clean water, placing said fillings in step 2 into the sterilized filling machine, and then putting said filling machine in a standing room to stand for 100-120 minutes;
step 4, molding meat paste noodle
a) connecting a discharge port of a pump in the noodle forming machine with a filling tube, clamping with a clip, adding gradually said fillings after standing in step 3 into the pump of the noodle forming machine, starting the pump of said noodle forming machine, and transferring said fillings to the discharge port of said filling tube by using said pump;
b) cleaning up the inside space of a drum-type heating and cooling machine, increasing the drumming steam temperature of the drum-type heating and cooling machine to an outside temperature between 90° C. and 95° C. and an inside temperature between 95° C. and 99° C., then transferring fillings from the discharge port of said filling tube into the drum-type heating and cooling machine, and outputting a meat paste dough sheet with a smooth surface from an output end of the drum-type heating and cooling machine;
step 5, cutting and shaping meat paste noodle
cutting the meat paste dough sheet output from the drum-type heating and cooling machine into strips with a filament cutter, and forming meat paste noodle, the cut meat paste noodle having a length of 22-30 cm, a thickness of 2-5 mm, a width of 2-5 mm and a weight of 1-2 g per strip;
step 6, arranging and freezing
shaking the cut meat paste noodle into a separated state, arranging it flatly in a single row within trays, and loading the trays into a refrigeratory for freezing according to the processing order of the meat paste noodle, wherein the refrigeratory is maintained at a temperature not higher than −25° C. and the freezing time is 4-6 hours.

2. The meat paste noodle of claim 1, characterized in that, said auxiliary materials are added in the following percentages by weight with respect to said main raw materials:
salts 1%, sugars 1.2%, gourmet powders 0.4%, meat flavor powders 0.2%, meat flavor oil 0.2%, and ethyl maltol 0.02%.
